(19) United States
(12) Patent Application Publication
(10) Pub. No.: US 2015/0353787 A1
(43) Pub. Date: Dec. 10, 2015

(54) WATER-DISPERSIBLE PRESSURE-SENSITIVE ADHESIVE COMPOSITION FOR TRANSPARENT CONDUCTIVE LAYER, PRESSURE-SENSITIVE ADHESIVE LAYER FOR TRANSPARENT CONDUCTIVE LAYER, PRESSURE-SENSITIVE ADHESIVE LAYER-ATTACHED OPTICAL FILM, AND LIQUID CRYSTAL DISPLAY DEVICE

(71) Applicant: NITTO DENKO CORPORATION, Ibaraki-shi, Osaka (JP)

(72) Inventors: Mizuho Nagata, Ibaraki-shi (JP); Kenichi Okada, Ibaraki-shi (JP); Toshitaka Takahashi, Ibaraki-shi (JP); Yousuke Makihata, Ibaraki-shi (JP); Kayo Shimokawa, Ibaraki-shi (JP); Toshitsugu Hosokawa, Ibaraki-shi (JP)

(73) Assignee: NITTO DENKO CORPORATION, Ibaraki-shi, Osaka (JP)

(21) Appl. No.: 14/655,933

(22) PCT Filed: Dec. 20, 2013
(86) PCT No.: PCT/JP2013/084313

§ 371 Date: Jun. 26, 2015

(30) Foreign Application Priority Data
Dec. 28, 2012 (JP) 2012-287737
Dec. 19, 2013 (JP) 2013-262192

(51) Int. Cl. C09J 133/08; C09J 7/02

(52) U.S. Cl. CPC C09J 133/08; C09J 7/0217; C09J 2433/00

(57) ABSTRACT

It is an object of the invention to provide a water-dispersible pressure-sensitive adhesive composition that is suitable for use on a transparent conductive layer and capable of forming a pressure-sensitive adhesive layer effective in suppressing the corrosion of various adherends such as transparent conductive thin coatings, in particular, effective in suppressing the corrosion in a high-temperature environment and a high-temperature, high-humidity environment, and capable of providing good optical properties on a transparent conductive layer. The invention is a water-dispersible pressure-sensitive adhesive composition for a transparent conductive layer, the composition comprising: a (meth)acryl-based polymer obtained by polymerizing, in the presence of a surfactant, a monomer component comprising an alkyl(meth)acrylate having an alkyl group of 4 to 14 carbon atoms, wherein the surfactant is a reactive surfactant having three or less oxyalkylene repeating units and/or a reactive surfactant having no oxyalkylene repeating unit.

### TECHNICAL FIELD

The invention relates to a water-dispersible pressure-sensitive adhesive composition for a transparent conductive layer, a pressure-sensitive adhesive layer for a transparent conductive layer, a pressure-sensitive adhesive layer-attached optical film, and a liquid crystal display device.

### BACKGROUND ART

Recently, a transparent conductive laminate including a transparent substrate made of a transparent resin film or a glass sheet and a transparent conductive thin coating such as an indium tin oxide (ITO) thin coating formed on one surface of the transparent substrate is widely used in a variety of applications.

For example, it is known that the transparent conductive thin coating is formed as an antistatic layer on one side of the transparent substrate of a liquid crystal cell opposite to its side in contact with its liquid crystal layer in a liquid crystal display device where the liquid crystal cell is of an in-plane switching (IPS) type or the like. In such a liquid crystal display device, a polarizing plate is formed on the transparent conductive thin coating with a pressure-sensitive adhesive layer interposed therebetween.

A transparent conductive film including a transparent substrate such as a resin film and a transparent conductive thin coating is used as a transparent electrode or the like, for example, in touch panels, liquid crystal displays, organic electroluminescent (EL) displays, solar cells, etc. Such a transparent conductive film includes a transparent resin film substrate, a transparent conductive thin coating made of a metal oxide and disposed on one surface of the transparent resin film substrate, and a pressure-sensitive adhesive layer disposed on the other surface of the transparent resin film substrate. When the transparent conductive film is used to form a laminate, the pressure-sensitive adhesive layer is brought into direct contact with a transparent conductive thin coating.

In such a case where a transparent conductive thin coating is brought into direct contact with a pressure-sensitive adhesive layer, the transparent conductive thin coating can be corroded so that its surface can have an increased resistance. This corrosion is considered to be caused by the carboxyl group component of a carboxyl group-containing acryl-based polymer in the pressure-sensitive adhesive layer, a surfactant migrating from the pressure-sensitive adhesive layer to the interface of the transparent conductive thin coating, and so on.

A known pressure-sensitive adhesive layer capable of solving the problem of such corrosion of the transparent conductive thin coating is made from, for example, a water-dispersible acrylic pressure-sensitive adhesive including: a (meth)acryl-based polymer containing a certain amount of a carboxyl group-containing monomer unit; and a certain amount of a water-soluble basic component (see, for example, Patent Document 1).

### PRIOR ART DOCUMENT

### Patent Document

Patent Document 1: JP-A-2012-31295

### SUMMARY OF THE INVENTION

### Problems to be Solved by the Invention

Patent Document 1 discloses that the water-soluble basic component in the pressure-sensitive adhesive layer can neutralize acid components such as carboxyl groups present in an acryl-based polymer, so that the corrosion of various adherends such as transparent conductive thin coatings as mentioned above can be suppressed. However, the pressure-sensitive adhesive layer has a problem in that when it is in contact with both a transparent conductive thin coating and an optical film such as a polarizing plate in a liquid crystal display device as mentioned above, it can degrade the optical properties of the optical film as one of the adherends while it can make the transparent conductive thin coating as the other adherend corrosion-resistant. Particularly, in recent years, optical films have been required to have a very high level of optical properties. Therefore, there has been a strong demand for the development of a pressure-sensitive adhesive layer that has little adverse effect on the optical properties of optical films and makes it possible to suppress the corrosion of transparent conductive layers.

Patent Document 1 discloses that an ammonium component is used as the water-soluble basic component. However, the ammonium component is highly volatile, and the amount of the ammonium component in the pressure-sensitive adhesive layer can easily vary with the coating and drying conditions and the like. It is therefore difficult to strictly control the corrosion resistance only by the control of the added amount of the ammonium component. From this viewpoint, there has been a strong demand for a method for suppressing the corrosion of transparent conductive layers without controlling the added amount of an ammonium component.

It is therefore an object of the invention to provide a water-dispersible pressure-sensitive adhesive composition that is suitable for use on a transparent conductive layer and capable of forming a pressure-sensitive adhesive layer effective in suppressing the corrosion of various adherends such as transparent conductive thin coatings, in particular, effective in suppressing the corrosion in a high-temperature environment and a high-temperature, high-humidity environment, and capable of providing good optical properties on a transparent conductive layer.

### Means for Solving the Problems

As a result of diligent studies to solve the problems, the inventors have accomplished the invention based on findings that the object can be achieved when a specific reactive surfactant is used to form a pressure-sensitive adhesive composition.

The invention relates to a water-dispersible pressure-sensitive adhesive composition for a transparent conductive layer, the composition comprising: a (meth)acryl-based polymer obtained by polymerizing, in the presence of a surfactant, a monomer component comprising an alkyl(meth)acrylate having an alkyl group of 4 to 14 carbon atoms, wherein the surfactant is a reactive surfactant having three or less oxyalkylene repeating units and/or a reactive surfactant having no oxyalkylene repeating unit.

In the water-dispersible pressure-sensitive adhesive composition of the invention, the surfactant is preferably a reactive surfactant having no oxyalkylene repeating unit.

In the water-dispersible pressure-sensitive adhesive composition of the invention, the surfactant is preferably added in an amount of 0.1 to 30 parts by weight based on 100 parts by weight of the total amount of the monomer component used to form the (meth)acryl-based polymer.

In the water-dispersible pressure-sensitive adhesive composition of the invention, the monomer component preferably further comprises a carboxyl group-containing monomer, and the carboxyl group-containing monomer is in an amount of 1 to 8 parts by weight based on 100 parts by weight of the alkyl(meth)acrylate having an alkyl group of 4 to 14 carbon atoms.

The water-dispersible pressure-sensitive adhesive composition of the invention preferably further comprises a water-soluble basic component. The water-soluble basic component is more preferably ammonia.

The water-dispersible pressure-sensitive adhesive composition of the invention preferably further comprises a phosphate ester compound. The phosphate ester compound is more preferably a non-polymerizable compound.

In the water-dispersible pressure-sensitive adhesive composition of the invention, the phosphate ester compound is preferably added in an amount of 0.005 to 5 parts by weight based on 100 parts by weight of the total amount of the monomer component used to form the (meth)acryl-based polymer.

The invention relates to a pressure-sensitive adhesive layer for a transparent conductive layer made from the water-dispersible pressure-sensitive adhesive composition of the invention.

The pressure-sensitive adhesive layer of the invention preferably contains 1,000 ng or less of a water-soluble basic component per 1 cm².

The invention relates to a pressure-sensitive adhesive layer-attached optical film, comprising:

an optical film; and

the pressure-sensitive adhesive layer of the invention provided on one surface of the optical film. The invention relates to a liquid crystal display device comprising the pressure-sensitive adhesive layer-attached optical film of the invention.

### Effect of the Invention

According to the invention, the water-dispersible pressure-sensitive adhesive composition for a transparent conductive layer includes a (meth)acryl-based polymer obtained by polymerizing, in the presence of a surfactant, a monomer component including an alkyl(meth)acrylate having an alkyl group of 4 to 14 carbon atoms, in which a reactive surfactant having three or less oxyalkylene repeating units and/or a reactive surfactant having no oxyalkylene repeating unit is used as the surfactant. Thus, the composition formed using the reactive surfactant makes it possible to form a pressure-sensitive adhesive layer that is suitable for use on a transparent conductive layer and effective in suppressing the corrosion of various adherends such as transparent conductive thin coatings, in particular, effective in suppressing the corrosion in a high-temperature environment and a high-temperature, high-humidity environment, and can provide good optical properties.

### BRIEF DESCRIPTION OF THE DRAWINGS

FIG. 1 is a cross-sectional view showing a pressure-sensitive adhesive layer-attached optical film according to the invention.

FIG. 2 is a cross-sectional view showing another pressure-sensitive adhesive layer-attached optical film according to the invention.

FIG. 3 is a cross-sectional view showing a liquid crystal display device according to the invention.

### MODE FOR CARRYING OUT THE INVENTION

The invention is directed to a water-dispersible pressure-sensitive adhesive composition for a transparent conductive layer. The composition includes a (meth)acryl-based polymer obtained by polymerizing, in the presence of a surfactant, a monomer component including an alkyl(meth)acrylate having an alkyl group of 4 to 14 carbon atoms, wherein the surfactant is a reactive surfactant having three or less oxyalkylene repeating units and/or a reactive surfactant having no oxyalkylene repeating unit. The invention is also directed to a pressure-sensitive adhesive layer for a transparent conductive layer. The pressure-sensitive adhesive layer is made from the water-dispersible pressure-sensitive adhesive composition. The invention is also directed to a pressure-sensitive adhesive layer-attached optical film and a liquid crystal display device.

1. Water-Dispersible Pressure-Sensitive Adhesive Composition for Transparent Conductive Layer

The water-dispersible pressure-sensitive adhesive composition of the invention for a transparent conductive layer includes a (meth)acryl-based polymer obtained by polymerizing, in the presence of a surfactant, a monomer component including an alkyl(meth)acrylate having an alkyl group of 4 to 14 carbon atoms, wherein the surfactant is a reactive surfactant having three or less oxyalkylene repeating units and/or a reactive surfactant having no oxyalkylene repeating unit.

The (meth)acryl-based polymer used in the invention is preferably dispersed in water to form an aqueous dispersion. More preferably, for example, the (meth)acryl-based polymer forms a polymer emulsion, which is obtained by emulsion polymerization of a monomer component including an alkyl(meth)acrylate having an alkyl group of 4 to 14 carbon atoms in the presence of a reactive surfactant, a radical polymerization initiator, and other components, which will be described below. As used herein, the term “alkyl(meth)acrylate” refers to an alkyl acrylate and/or an alkyl methacrylate, and “(meth)” is used in the same meaning in the description.

The alkyl group of 4 to 14 carbon atoms in the alkyl(meth)acrylate may be any of various straight or branched chain alkyl groups. Examples of the alkyl(meth)acrylate include n-butyl(meth)acrylate, isobutyl(meth)acrylate, sec-butyl(meth)acrylate, tert-butyl(meth)acrylate, n-pentyl(meth)acrylate, isopentyl(meth)acrylate, isoamyl(meth)acrylate, n-hexyl(meth)acrylate, heptyl(meth)acrylate, 2-ethylhexyl(meth)acrylate, isooctyl(meth)acrylate, n-nonyl(meth)acrylate, isononyl(meth)acrylate, n-decyl(meth)acrylate, isodecyl(meth)acrylate, n-dodecyl(meth)acrylate, isomyristyl(meth)acrylate, n-tridecyl(meth)acrylate, tetradecyl(meth)acrylate, etc. These may be used alone or in any combination. In particular, n-butyl(meth)acrylate and 2-ethylhexyl(meth)acrylate are preferred, n-butyl(meth)acrylate is particularly preferred.

The content of the alkyl(meth)acrylate having an alkyl group of 4 to 14 carbon atoms in the monomer component used to form the (meth)acryl-based polymer is preferably 60% by weight or more, more preferably 70% by weight or more, even more preferably 80% by weight or more, further more preferably 90% by weight or more.

The (meth)acryl-based polymer used in the invention is obtained by polymerization of a monomer component including an alkyl(meth)acrylate having an alkyl group of 4 to 14 carbon atoms. Preferably, the (meth)acryl-based polymer used in the invention is obtained by polymerization of a monomer component including an alkyl(meth)acrylate having an alkyl group of 4 to 14 carbon atoms and a carboxyl group-containing monomer.

Any monomer having a carboxyl group and an unsaturated double bond-containing polymerizable functional group such as a (meth)acryloyl group or a vinyl group may be used without restriction as the carboxyl group-containing monomer. Examples of the carboxyl group-containing monomer include acrylic acid, methacrylic acid, carboxyethyl(meth)acrylate, carboxypentyl(meth)acrylate, itaconic acid, maleic acid, fumaric acid, and crotonic acid. These may be used alone or in any combination. Among these, acrylic acid and methacrylic acid are preferred, and acrylic acid is particularly preferred.

The carboxyl group-containing monomer is preferably used in an amount of 1 to 8 parts by weight, more preferably 2 to 7 parts by weight, even more preferably 3 to 7 parts by weight, based on 100 parts by weight of the alkyl(meth)acrylate having an alkyl group of 4 to 14 carbon atoms. If the carboxyl group-containing monomer is used in an amount of less than 1 part by weight, the resulting pressure-sensitive adhesive layer for a transparent conductive layer may have reduced adhesion to the adherend, or the pressure-sensitive adhesive composition itself may have reduced cohesive strength, so that foaming or peeling may tend to occur in a high-temperature environment and a high-temperature, high-humidity environment, the aqueous dispersion may tend to less stable, and aggregate-induced degradation of coating appearance may tend to occur. If the carboxyl group-containing monomer is used in an amount of more than 8 parts by weight, the dispersion stability may be reduced during the polymerization, or the viscosity of the aqueous dispersion may significantly increase, which may tend to affect the coating and is not preferred.

Besides the alkyl(meth)acrylate and the carboxyl group-containing monomer, the monomer component may also contain a copolymerizable monomer or monomers capable of being copolymerized with the alkyl(meth)acrylate and the carboxyl group-containing monomer.

The copolymerizable monomer may be of any type having an unsaturated double bond-containing polymerizable functional group such as a (meth)acryloyl group or a vinyl group, examples of which include an alkyl(meth)acrylate having an alkyl group of 1 to 3 carbon atoms or 15 or more carbon atoms; alicyclic hydrocarbon esters of (meth)acrylic acid, such as cyclohexyl(meth)acrylate, bornyl(meth)acrylate, and isobornyl(meth)acrylate; aryl(meth)acrylate such as phenyl(meth)acrylate; vinyl esters such as vinyl acetate and vinyl propionate; styrene monomers such as styrene; epoxy group-containing monomers such as glycidyl(meth)acrylate and methylglycidyl(meth)acrylate; hydroxyl group-containing monomers such as 2-hydroxyethyl acrylate and 2-hydroxypropyl acrylate; nitrogen atom-containing monomers such as (meth)acrylamide, N,N-dimethyl(meth)acrylamide, N,N-diethyl(meth)acrylamide, N-isopropyl(meth)acrylamide, N-butyl(meth)acrylamide, N-methylol(meth)acrylamide, N-methylolpropane(meth)acrylamide, (meth)acryloylmorpholine, aminoethyl(meth)acrylate, N,N-dimethylaminoethyl(meth)acrylate, and tert-butylaminoethyl(meth)acrylate; alkoxy group-containing monomers such as methoxyethyl(meth)acrylate and ethoxyethyl(meth)acrylate; cyano group-containing monomers such as acrylonitrile and methacrylonitrile; functional monomers such as 2-methacryloyloxyethyl isocyanate; olefin monomers such as ethylene, propylene, isoprene, butadiene, and isobutylene; vinyl ether monomers such as vinyl ether; halogen atom-containing monomers such as vinyl chloride; and other monomers including vinyl group-containing heterocyclic compounds such as N-vinylpyrrolidone, N-(1-methylvinyl)pyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, and N-vinylmorpholine, and N-vinylcarboxylic acid amides.

Examples of the copolymerizable monomer also include maleimide monomers such as N-cyclohexylmaleimide, N-isopropylmaleimide, N-laurylmaleimide, and N-phenylmaleimide; itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide; succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide; and sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl(meth)acrylate, and (meth)acryloyloxynaphthalenesulfonic acid.

The copolymerizable monomer may also be a phosphate group-containing monomer. For example, the phosphate group-containing monomer may be a phosphate group-containing monomer represented by the following formula (1):

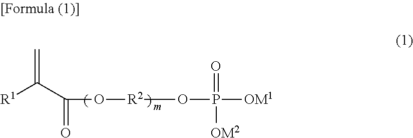

wherein R¹ represents a hydrogen atom or a methyl group, R² represents an alkylene group of 1 to 4 carbon atoms, m represents an integer of 2 or more, and M¹ and M² each independently represent a hydrogen atom or a cation.

In formula (1), m is an integer of 2 or more, preferably an integer of 4 or more, generally an integer of 40 or less, and m represents the degree of polymerization of the oxyalkylene groups. The polyoxyalkylene group may be a polyoxyethylene group or a polyoxypropylene group, and these polyoxyalkylene groups may comprise random, block, or graft units. The cation of the salt of the phosphate group is typically, but not limited to, an inorganic cation such as an alkali metal such as sodium or potassium or an alkaline-earth metal such as calcium or magnesium, or an organic cation such as a quaternary amine.

Examples of the copolymerizable monomer also include glycol acrylate monomers such as polyethylene glycol(meth)acrylate, polypropylene glycol(meth)acrylate, methoxyethylene glycol(meth)acrylate, and methoxypolypropylene glycol(meth)acrylate; and other monomers such as acrylic ester monomers containing a heterocyclic ring or a halogen atom, such as tetrahydrofurfuryl(meth)acrylate and fluoro(meth)acrylate.

A polyfunctional monomer may also be used as the copolymerizable monomer for a purpose such as control of the gel fraction of the water-dispersible acryl-based pressure-sensitive adhesive. The polyfunctional monomer may be a compound having two or more unsaturated double bonds such as those in (meth)acryloyl groups or vinyl groups. Examples that may also be used include (meth)acrylate esters of polyhydric alcohols, such as (mono or poly)alkylene glycol di(meth)acrylates including (mono or poly)ethylene glycol di(meth)acrylates such as ethylene glycol di(meth)acrylate, diethylene glycol di(meth)acrylate, triethylene glycol di(meth)acrylate, trimethylolpropane tri(meth)acrylate, and tetraethylene glycol di(meth)acrylate, (mono or poly)propylene glycol di(meth)acrylate such as propylene glycol di(meth)acrylate, neopentyl glycol di(meth)acrylate, 1,6-hexanediol di(meth)acrylate, pentaerythritol di(meth)acrylate, trimethylolpropane tri(meth)acrylate, pentaerythritol tri(meth)acrylate, and dipentaerythritol hexa(meth)acrylate; polyfunctional vinyl compounds such as divinylbenzene; and compounds having a reactive unsaturated double bond, such as allyl(meth)acrylate and vinyl(meth)acrylate. The polyfunctional monomer may also be a compound having a polyester, epoxy or urethane skeleton to which two or more unsaturated double bonds are added in the form of functional groups such as (meth)acryloyl groups or vinyl groups in the same manner as the monomer component, such as polyester(meth)acrylate, epoxy(meth)acrylate, or urethane(meth)acrylate.

The content of the copolymerizable monomer other than the carboxyl group-containing monomer is preferably 40 parts by weight or less, more preferably 30 parts by weight or less, even more preferably 20 parts by weight or less, still more preferably 10 parts by weight or less, based on 100 parts by weight of the alkyl(meth)acrylate having an alkyl group of 4 to 14 carbon atoms. If the content of the copolymerizable monomer is too high, the pressure-sensitive adhesive layer of the invention made from the water-dispersible pressure-sensitive adhesive composition for transparent conductive layer may have degraded pressure-sensitive adhesive properties such as degraded adhesion to various adherends such as glass, films, and transparent conductive thin coatings.

Among copolymerizable monomers other than the carboxyl group-containing monomer, a phosphate group-containing monomer is preferably used so that the aqueous dispersion (emulsion or the like) can be stabilized or the pressure-sensitive adhesive layer made from the aqueous dispersion can have reliable adhesion to various adherends. When the copolymerizable monomer is a phosphate group-containing monomer, the content of the phosphate group-containing monomer is preferably from 0.5 to 5 parts by weight, more preferably from 1 to 4 parts by weight, even more preferably from 1 to 3 parts by weight based on 100 parts by weight of the alkyl(meth)acrylate. When the phosphate group-containing monomer is used within these ranges, foaming, peeling, or yellowing in a high-temperature or high-temperature, high-humidity environment, and corrosion of the transparent conductive thin coatings in a high-temperature, high-humidity environment can be further suppressed.

The emulsion polymerization of the monomer component is performed by polymerizing the monomer component in the presence of a specific surfactant, which will be described below. This process is used to prepare an aqueous dispersion containing a dispersed (meth)acryl-based polymer. In the emulsion polymerization, for example, the monomer component is mixed, in water, with a surfactant, a radial polymerization initiator, and an optional material such as a chain transfer agent, which will be described below. More specifically, for example, a known emulsion polymerization method such as a batch mixing method (batch polymerization method), a monomer dropping method, or a monomer emulsion dropping method may be used. In a monomer dropping method, continuous dropping or intermittent dropping is appropriately selected. These methods may be combined as needed. Reaction conditions and other conditions are appropriately selected, in which, for example, the polymerization temperature may be from about 20 to about 90° C.

The surfactant used in the invention is a reactive surfactant. As used herein, the term “reactive surfactant” refers to a surfactant having one or more radically-polymerizable, unsaturated double bonds in the molecule. The radically-polymerizable, unsaturated double bond may be of, for example, a vinyl group, a vinyloxy group, an allyl group, an acryloyl group, a methacryloyl group, or the like.

The reactive surfactant has a high ability to emulsify monomers. Therefore, a highly stable aqueous dispersion of polymer particles can be produced using the reactive surfactant. The reactive surfactant used in the invention has no oxyalkylene repeating unit, or if the reactive surfactant has oxyalkylene repeating units, the number of the repeating units in it is 3 or less (preferably 2 or less).

In the invention, the reactive surfactant may be a compound represented by formula (2):

### Formula 2

M³O₃S—R³—CH═CH₂ (2)

wherein R³ is a divalent organic group having three or less oxyalkylene repeating units or no oxyalkylene repeating unit and optionally having an oxygen atom, and M³ is Na, K, or NH₄, wherein the oxyalkylene repeating unit is a group represented by the following formula:

### Formula 3

R⁴—O

wherein R⁴ is an alkylene group of 1 to 20 carbon atoms. The reactive surfactant used in the invention is free of this oxyalkylene repeating unit, or this oxyalkylene repeating unit is repeated three times or less (preferably twice or less) in the reactive surfactant used in the invention. The divalent organic group may be, but not limited to, a divalent hydrocarbon group optionally having an ether bond or an ester bond.

Examples of such a reactive surfactant include a compound represented by formula (3):

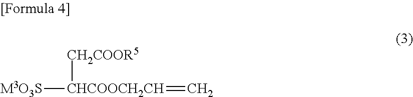

wherein M³ has the same meaning as defined above, and R⁵ is an alkyl group of 1 to 20 carbon atoms, and a compound represented by formula (4):

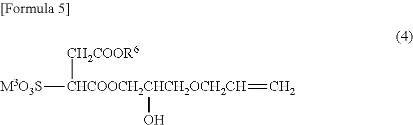

wherein M³ has the same meaning as defined above, and R⁶ is an alkyl group of 1 to 20 carbon atoms.

In formulae (2) to (4), M³ is preferably Na, K, or NH₄. R⁵ and R⁶ are each an alkyl group of 1 to 20 carbon atoms, preferably an alkyl group of 10 to 20 carbon groups.

More specifically, examples of the reactive surfactant that may be used in the invention include ELEMINOL JS-20 (manufactured by Sanyo Chemical Industries, Ltd.) and LATEMUL S-180A (manufactured by Kao Corporation).

The content of the reactive surfactant is, for example, preferably from 0.1 to 30 parts by weight, more preferably from 0.1 to 20 parts by weight, even more preferably from 0.1 to 10 parts by weight, further more preferably from 0.5 to 5 parts by weight, based on 100 parts by weight of the total amount of the monomer component used to form the (meth)acryl-based polymer. Advantageously, when the content of the reactive surfactant falls within the range, high polymerization stability can be achieved, and transparent conductive thin coatings and various other adherends can be prevented from being corroded.

Conventional water-dispersible pressure-sensitive adhesive compositions, which contain an acryl-based polymer that has an acid component such as a carboxyl group and is obtained by polymerization in the presence of a surfactant having an oxyethylene or oxypropylene chain, have a problem in that the surfactant in the resulting bulk pressure-sensitive adhesive layer can easily migrate to the adherend (transparent conductive coating) and if such migration occurs, it can cause corrosion of the transparent conductive coating. A known method for suppressing such corrosion includes adding a water-soluble basic component. In this method, however, if the content of the water-soluble basic component in the pressure-sensitive adhesive layer is low (e.g., 1,200 μg/cm² or less), the corrosion of the transparent conductive coating will tend to occur. In addition, this phenomenon is more significant in a high-temperature, high-humidity environment.

As mentioned above, the corrosion of the transparent conductive coating seems to be caused by such migration of a surfactant to the transparent conductive coating or by the presence of the carboxyl component in the pressure-sensitive adhesive layer. According to the features of the invention, however, good dispersion of the surfactant can be maintained regardless of the presence or absence and the content of a water-soluble basic component, so that the corrosion of the transparent conductive coating can be effectively suppressed. When the corrosion is suppressed, an increase in the resistance of the adherend surface is also suppressed.

In the invention, any emulsifying agent commonly used in emulsion polymerization may be used as long as the effects of the invention are not impaired. Examples of the emulsifying agents include anionic emulsifying agents such as sodium lauryl sulfate, ammonium lauryl sulfate, sodium dodecylbenzenesulfonate, sodium polyoxyethylene lauryl sulfate, sodium polyoxyethylene alkyl ether sulfate, ammonium polyoxyethylene alkyl phenyl ether sulfate, sodium polyoxyethylene alkyl phenyl ether sulfate, and sodium polyoxyethylene alkyl sulfosuccinate; and nonionic emulsifying agents such as polyoxyethylene alkyl ether, polyoxyethylene alkyl phenyl ether, polyoxyethylene fatty acid ester, and polyoxyethylene-polyoxypropylene block polymers.

The content of the emulsifying agent is preferably 1 part by weight or less, more preferably 0.5 parts by weight or less, based on the 100 parts by weight of the monomer component including the alkyl(meth)acrylate as a main component. No addition of the emulsifying agent is more preferred. The content of the emulsifying agent is preferably 10% by weight or less of the content of the reactive surfactant.

The radical polymerization initiator may be, but not limited to, any known radical polymerization initiator commonly used in emulsion polymerization. Examples include azo initiators such as 2,2′-azobisisobutylonitrile, 2,2′-azobis(2-methylpropionamidine)disulfate, 2,2′-azobis(2-methylpropionamidine)dihydrochloride, 2,2′-azobis(2-amidinopropane)dihydrochloride, and 2,2′-azobis[2-(2-imidazoline-2-yl)propane]dihydrochloride; persulfate initiators such as potassium persulfate and ammonium persulfate; peroxide initiators such as benzoyl peroxide, tert-butyl hydroperoxide, and hydrogen peroxide; substituted ethane initiators such as phenyl-substituted ethane; and carbonyl initiators such as aromatic carbonyl compounds. These polymerization initiators may be appropriately used alone or in any combination.

The content of the radical polymerization initiator may be appropriately selected. For example, the content of the radical polymerization initiator is preferably, but not limited to, about 0.01 to about 0.5 parts by weight based on 100 parts by weight of the monomer component. If it is less than 0.01 parts by weight, the effect of the radical polymerization initiator may tend to be low, and if it is more than 0.5 parts by weight, the water-dispersible (meth)acryl-based polymer may tend to have a lower molecular weight, and the water-dispersible pressure-sensitive adhesive composition may tend to have lower adherability.

A chain transfer agent is optionally used to control the molecular weight of the (meth)acryl-based polymer. In general, chain transfer agents commonly used in emulsion polymerization are used. Examples include 1-dodecanthiol, mercaptoacetic acid, 2-mercaptoethanol, 2-ethylhexyl thioglycolate, 2,3-dimercapto-1-propanol, mercaptopropionic acid esters, and other mercaptans. These chain transfer agents may be appropriately used alone or in any combination. For example, the content of the chain transfer agent is preferably 0.3 part by weight or less, more preferably from 0.001 to 0.3 parts by weight based on 100 parts by weight of the monomer components.

According to the emulsion polymerization described above, the water-dispersible (meth)acryl-based polymer can be prepared in the form of an aqueous dispersion (emulsion). The average particle size of such a water-dispersible (meth)acryl-based polymer is preferably controlled in the range of 0.05 to 3 μm, more preferably in the range of 0.05 to 1 μm.

In view of heat resistance and humidity resistance, the (meth)acryl-based polymer used in the invention preferably has a weight average molecular weight of 1,000,000 or more, more preferably 1,000,000 to 4,000,000. The pressure-sensitive adhesive obtained by the emulsion polymerization is preferred because the polymerization mechanism allows the polymer to have a very high molecular weight. It should be noted that the pressure-sensitive adhesive obtained by the emulsion polymerization usually has a high gel content and cannot be subjected to gel permeation chromatography (GPC) measurement, which means that it is often difficult to identify the molecular weight by actual measurement.

The water-dispersible pressure-sensitive adhesive composition of the invention may contain a water-soluble basic component in addition to the water-dispersible (meth)acryl-based polymer. The water-soluble basic component is a compound capable of forming a salt upon an acid-base neutralization reaction with the carboxyl group of the water-dispersible (meth)acryl-based polymer. In general, the water-soluble basic component is a compound that exhibits alkalinity in an aqueous solution when dissolved in water. Examples of the water-soluble basic component include alkanolamines such as 2-dimethylaminoethanol, diethanolamine, triethanolamine, and aminomethyl propanol; alkylamines such as trimethylamine, triethylamine, and butylamine; polyalkylene polyamines such as ethylenediamine, diethylenetriamine, triethylenetetramine, and tetraethylenepentamine; and other organic amine compounds such as ethyleneimine, polyethyleneimine, imidazole, 2-methylimidazole, pyridine, aniline, and morpholine. Examples of the water-soluble basic component further include inorganic basic compounds such as alkali metal hydroxides including sodium hydroxide and potassium hydroxide; and alkaline-earth metal hydroxides including barium hydroxide, calcium hydroxide, and aluminum hydroxide; and ammonia. Among these, ammonia is preferred in view of the effect of stabilizing the aqueous dispersion by the addition of the water-soluble basic component for the neutralization, the easiness of controlling viscosity to an appropriate level where streaks or unevenness does not occur when the water-dispersible acryl-based pressure-sensitive adhesive is applied, and the balance between the corrosion resistance and the durability of the pressure-sensitive adhesive layer after applying and drying.

The amount of the water-soluble basic component is preferably controlled to 2,500 ng or less, more preferably 10 to 1,500 ng, even more preferably 10 to 750 ng, per 1 cm² of the pressure-sensitive adhesive layer made from the water-dispersible pressure-sensitive adhesive composition of the invention. If the amount of the water-soluble basic component is more than 2,500 ng, a polarizing plate used as the optical film may have a reduced degree of polarization, which may tend to have an adverse effect on the optical properties.

A description is given of an example in which ammonia or sodium hydroxide is used as the water-soluble basic component. Ammonia may be used in the form of an ammonia water, and in general, the ammonia water is preferably added in an amount containing about 0.1 to about 20 parts by weight of ammonia, more preferably 0.2 to 5 parts by weight of ammonia, based on 100 parts by weight of the solid in the aqueous dispersion containing the (meth)acryl-based polymer. Sodium hydroxide may be used in the form of an aqueous sodium hydroxide solution, and in general, the aqueous sodium hydroxide solution is preferably added in an amount containing about 0.05 to about 5 parts by weight of sodium hydroxide, more preferably 0.1 to 3 parts by weight of sodium hydroxide, based on 100 parts by weight of the solid in the aqueous dispersion containing the (meth)acryl-based polymer.

The water-dispersible pressure-sensitive adhesive composition of the invention may contain a phosphate ester compound in addition to the water-dispersible (meth)acryl-based polymer. The addition of the phosphate ester compound can enhance the corrosion-suppressing effect. This would be because of the following. The mobility of the phosphate ester compound is relatively high, and the affinity of the phosphate ester compound for a transparent conductive thin coating such as an ITO thin coating is almost equal to or higher than that of the surfactant. Therefore, the phosphate ester compound in the pressure-sensitive adhesive composition can selectively adsorb onto the surface of the transparent conductive layer to form a film, which can be effective in suppressing the corrosion of the transparent conductive thin coating and particularly effective in suppressing the corrosion in a high-temperature environment and a high-temperature, high-humidity environment.

The phosphate ester compound is preferably a non-polymerizable compound. The non-polymerizable compound refers to a compound that has no polymerizable group and does not undergo polymerization when incorporated into the water-dispersible pressure-sensitive adhesive composition. Therefore, the term “non-polymerizable compound” is not intended to include an unreacted residue (phosphate group-containing monomer) that is left after the polymerization of the monomer component containing, for example, a phosphate group-containing monomer or the like. In the invention, the term “non-polymerizable compound” is also not intended to include polymers, oligomers, or other products obtained through polymerization of the monomer component containing, for example, a phosphate group-containing monomer.

The phosphate ester compound is preferably not reactive with the monomer component. Advantageously, when the phosphate ester compound is not reactive with the monomer component, it is hardly incorporated into the (meth)acryl-based polymer and can reliably have high mobility in the pressure-sensitive adhesive composition.

Examples of the phosphate ester compound include a phosphate ester compound represented by formula (5) below and a salt thereof.

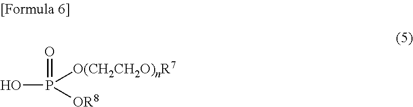

In the formula, R⁷ is an alkyl or alkenyl group of 2 to 18 carbon atoms, R⁸ is a hydrogen atom or—(CH₂CH₂O)ₙR⁹, wherein R⁹ is an alkyl or alkenyl group of 2 to 18 carbon atoms, and n is an integer of 0 to 15.

R⁷ is an alkyl or alkenyl group of 2 to 18 carbon atoms, preferably an alkyl group of 2 to 18 carbon atoms, more preferably an alkyl group of 4 to 15 carbon atoms. R⁸ may be linear or branched and is preferably linear.

R⁸ is a hydrogen atom or —(CH₂CH₂O)ₙR⁹. Examples of R⁹ may include those of R⁷. When R⁸ is a hydrogen atom, the compound of formula (5) is a monoester. When R⁸ is —(CH₂CH₂O)ₙR⁹, the compound of formula (5) is a diester. When R⁸ is —(CH₂CH₂O)ₙR⁹, R⁷ and R⁹ may be the same or different.

The letter n represents an integer of 0 to 15, preferably an integer of 0 to 10. In the invention, a mixture of two or more phosphate ester compounds of formula (5) having different R⁷ moieties may be used, or a mixture of a monoester (R⁸:H) and a diester (R⁸:—(CH₂CH₂O)ₙR⁹) may be used. The phosphate ester compound of formula (5) is usually obtained in the form of a mixture of a monoester and a diester.

In the invention, a salt (such as a metal salt such as a sodium, potassium, or magnesium salt, or an ammonium salt) of the phosphate ester compound of formula (5) is also preferably used.

Commercially available products of the phosphate ester compound of formula (5) include PHOSPHANOL SM-172 (R⁷═R⁹═C₈H₁₇, mono-di mixture, n=0), PHOSPHANOL GF-185 (R⁷═R⁹═C₁₃H₂₇ mono-di mixture, n=0), PHOSPHANOL BH-650 (R⁷═R⁹═C₄H₉, mono-di mixture, n=1), PHOSPHANOL RS-710 (R⁷═C₁₃H₂₇, R⁹═C₁₃H₂₇ mono-di mixture, n=10), PHOSPHANOL ML-220 (R⁷═R⁹═C₁₂H₂₅, mono-di mixture, n=2), PHOSPHANOL ML-200 (R⁷═R⁹═C₁₂H₂₅, mono-di mixture, n=0), PHOSPHANOL ED-200 (R⁷═R⁹═C₈H₁₇, mono-di mixture, n=1), PHOSPHANOL RL-210 (R⁷═R⁹═C₁₈H₃₇, mono-di mixture, n=2), PHOSPHANOL RS-410 (R⁷═R⁹═C₁₃H₂₇, mono-di mixture, n=3), PHOSPHANOL GF-339 (R⁷═R⁹═C₆H₁₃ to C₁₀H₂₁, mono-di mixture, n=0), PHOSPHANOL GF-199 (R⁷═R⁹═C₁₂H₂₅, mono-di mixture, n=0), and PHOSPHANOL RL-310 (R⁷═R⁹═C₁₈H₂₇, mono-di mixture, n=3), all manufactured by TOHO Chemical Industry Co., Ltd.; NIKKOL DDP-2 (a mixture of R⁷═R⁹═C₁₂H₂₅ to C₁₅H₃1, n=2) manufactured by Nikko Chemicals Co., Ltd.; and salts thereof. The term “mono-di mixture” means a mixture of a monoester (R⁸═H) and a diester (R⁸=—(CH₂CH₂O)ₙR⁹).

The phosphate ester compound is preferably added in an amount of 0.005 to 5 parts by weight, more preferably 0.01 to 2 parts by weight, even more preferably 0.01 to 1.5 parts by weight, based on 100 parts by weight of the monomer component. Advantageously, when the added amount of the phosphate ester compound falls within the range, an increase in the surface resistance of the transparent conductive thin coating can be further suppressed.

The phosphate ester compound is preferably added to the monomer composition before the polymerization. This is because when the phosphate ester compound is added before the polymerization, it can be highly dispersed in the pressure-sensitive adhesive layer, so that the above advantageous effects can be easily obtained.

To improve adhesion under high-temperature, high-humidity conditions, any of various silane coupling agents may be added to the water-dispersible pressure-sensitive adhesive composition of the invention. Silane coupling agents having any appropriate functional group may be used. Examples of such a functional group include vinyl, epoxy, amino, mercapto, (meth)acryloxy, acetoacetyl, isocyanate, styryl, and polysulfide groups. Examples of the silane coupling agent include a vinyl group-containing silane coupling agent such as vinyltriethoxysilane, vinyltripropoxysilane, vinyltriisopropoxysilane, or vinyltributoxysilane; an epoxy group-containing silane coupling agent such as γ-glycidoxypropyltrimethoxysilane, γ-glycidoxypropyltriethoxysilane, 3-glycidoxypropylmethyldiethoxysilane, or 2-(3,4-epoxycyclohexyl)ethyltrimethoxysilane; an amino group-containing silane coupling agent such as γ-aminopropyltrimethoxysilane, N-μ-(aminoethyl)-γ-aminopropylmethyldimethoxysilane, N-(2-aminoethyl) 3-aminopropylmethyldimethoxysilane, γ-triethoxysilyl-N-(1,3-dimethylbutylidene)propylamine, or N-phenyl-γ-aminopropyltrimethoxysilane; a mercapto group-containing silane coupling agent such as γ-mercaptopropylmethyldimethoxysilane, a styryl group-containing silane coupling agent such as p-styryltrimethoxysilane; a (meth)acrylic group-containing silane coupling agent such as γ-acryloxypropyltrimethoxysilane or γ-methacryloxypropyltriethoxysilane; an isocyanate group-containing silane coupling agent such as 3-isocyanatepropyltriethoxysilane; and a polysulfide group-containing silane coupling agent such as bis(triethoxysilylpropyl)tetrasulfide.

Among the silane coupling agents, silane coupling agents having a radically polymerizable group copolymerizable with the above monomer component, such as a vinyl group, a (meth)acryloxy group, or a styryl group are preferred, and in view of reactivity, silane coupling agents having a (meth)acryloxy group are particularly preferred. For example, include (meth)acryloyloxyalkyl-trialkoxysilanes such as (meth)acryloyloxymethyl-trimethoxysilane, (meth)acryloyloxymethyl-triethoxysilane, 2-(meth)acryloyloxyethyl-trimethoxysilane, 2-(meth)acryloyloxyethyl-triethoxysilane, 3-(meth)acryloyloxypropyl-trimethoxysilane, 3-(meth)acryloyloxypropyl-triethoxysilane, 3-(meth)acryloyloxypropyl-tripropoxysilane, 3-(meth)acryloyloxypropyl-triisopropoxysilane, and 3-(meth)acryloyloxypropyl-tributoxysilane; (meth)acryloyloxyalkyl-alkyldialkoxysilanes such as (meth)acryloyloxymethyl-methyldimethoxysilane, (meth)acryloyloxymethyl-methyldiethoxysilane, 2-(meth)acryloyloxyethyl-methyldimethoxysilane, 2-(meth)acryloyloxyethyl-methyldiethoxysilane, 3-(meth)acryloyloxypropyl-methyldimethoxysilane, 3-(meth)acryloyloxypropyl-methyldiethoxysilane, 3-(meth)acryloyloxypropyl-methyldipropoxysilane, 3-(meth)acryloyloxypropyl-methyldiisopropoxysilane, 3-(meth)acryloyloxypropyl-methyldibutoxysilane, 3-(meth)acryloyloxypropyl-ethyldimethoxysilane, 3-(meth)acryloyloxypropyl-ethyldiethoxysilane, 3-(meth)acryloyloxypropyl-ethyldipropoxysilane, 3-(meth)acryloyloxypropyl-ethyldiisopropoxysilane, 3-(meth)acryloyloxypropyl-ethyldibutoxysilane, 3-(meth)acryloyloxypropyl-propyldimethoxysilane, and 3-(meth)acryloyloxypropyl-propyldiethoxysilane; and (meth)acryloyloxyalkyl-dialkyl(mono)alkoxysilanes corresponding to these monomers.

The silane coupling agents may be used alone or in combination of two or more. Based on 100 parts by weight of the (meth)acryl-based polymer, the total content of the silane coupling agent (s) is preferably 1 part by weight or less, more preferably from 0.01 to 1 part by weight, even more preferably from 0.02 to 0.8 parts by weight, still more preferably from 0.05 to 0.7 parts by weight. If the content of the silane coupling agent is more than 1 part by weight, part of the coupling agent may remain unreacted, which is not preferred in view of durability.

When the silane coupling agent is radically copolymerizable with the above monomer component, it may be used as one of the monomer components. In such a case, the content of the silane coupling agent is preferably from 0.005 to 0.7 parts by weight based on 100 parts by weight of the alkyl(meth)acrylate.

If necessary, the water-dispersible pressure-sensitive adhesive composition of the invention may further appropriately contain any of various additives such as viscosity adjusting agent, crosslinking agents, releasing adjusting agent, tackifiers, plasticizers, softener, fillers including glass fibers, glass beads, metal power, or any other inorganic powder, pigments, colorants (pigments, dyes or the likes), pH adjusting agent (acid or base), antioxidants, and ultraviolet ray absorbing agents, without departing from the objects of the invention. These additives may also be added in the form of dispersion.

In particular, a crosslinking agent is preferably used, because it can provide a cohesive strength, which is related to the durability of the pressure-sensitive adhesive. A polyfunctional compound may be used as a crosslinking agent, examples of which include an organic crosslinking agent and a polyfunctional metal chelate. Examples of the organic crosslinking agent include an epoxy crosslinking agent, an isocyanate crosslinking agent, a carbodiimide crosslinking agent, an imine crosslinking agent, an oxazoline crosslinking agent, an aziridine crosslinking agent, etc. The organic crosslinking agent is preferably an isocyanate crosslinking agent or a carbodiimide crosslinking agent. The polyfunctional metal chelate may comprise a polyvalent metal and an organic compound that is covalently or coordinately bonded to the metal. Examples of the polyvalent metal atom include Al, Cr, Zr, Co, Cu, Fe, Ni, V, Zn, In, Ca, Mg, Mn, Y, Ce, Sr, Ba, Mo, La, Sn, and Ti. The organic compound has a covalent or coordinate bond-forming atom such as an oxygen atom. Examples of the organic compound include an alkyl ester, an alcohol compound, a carboxylic acid compound, an ether compound, and a ketone compound.

The content of the crosslinking agent in the water-dispersible pressure-sensitive adhesive composition is generally, but not limited to, about 10 parts by weight or less (on a solid basis), based on 100 parts by weight of the (meth)acryl-based polymer (on a solid basis). The content of the crosslinking agent is preferably from 0.01 to 10 parts by weight, more preferably from about 0.1 to about 5 parts by weight.

2. Pressure-Sensitive Adhesive Layer for Transparent Conductive Layer

The pressure-sensitive adhesive layer of the invention for a transparent conductive layer is made from the water-dispersible pressure-sensitive adhesive composition for a transparent conductive layer.

A method for producing the pressure-sensitive adhesive layer of the invention for a transparent conductive layer may include, but is not limited to, applying, to any substrate, the water-dispersible pressure-sensitive adhesive composition for a transparent conductive layer; and drying the composition with a drier such as a heating oven to remove water and any excess of the water-soluble basic component by vaporization, so that the pressure-sensitive adhesive layer is formed. For example, the substrate may be, but is not limited to, a release film, a transparent resin film, or any of various other substrates. The optical film described below is also advantageously used as the substrate.

Any of various methods may be used to apply, to the substrate, the water-dispersible pressure-sensitive adhesive composition for a transparent conductive layer. Examples include roll coating, kiss roll coating, gravure coating, reverse coating, roll brushing, spray coating, dip roll coating, bar coating, knife coating, air knife coating, curtain coating, lip coating, and extrusion coating with a die coater or the like.

The drying conditions (temperature and time) are not limited and may be appropriately selected depending on the components, concentration, or other features of the water-dispersible pressure-sensitive adhesive composition for a transparent conductive layer. For example, the drying conditions may be about 80 to about 170° C. and 1 to 60 minutes, preferably 90 to 150° C. and 3 to 30 minutes.

The thickness of the pressure-sensitive adhesive layer (after the drying) is, for example, preferably from 10 to 100 μm, more preferably from 15 to 80 μm, even more preferably from 20 to 60 μm. If the pressure-sensitive adhesive layer has a thickness of less than 10 μm, it may have lower adhesion to the adherend and tend to have insufficient durability in a high-temperature or high-temperature, high-humidity environment. If the pressure-sensitive adhesive layer has a thickness of more than 100 μm, a problem with its appearance may tend to become significant because water may fail to be sufficiently removed in the process of forming the pressure-sensitive adhesive layer by applying and drying the water-dispersible pressure-sensitive adhesive composition for a transparent conductive layer so that bubbles may remain or the pressure-sensitive adhesive layer may have thickness irregularities.

Examples of the material used to form the release film include a resin film such as a polyethylene, polypropylene, polyethylene terephthalate, or polyester film, a porous material such as paper, fabric, or nonwoven fabric, and an appropriate thin material such as a net, a foamed sheet, a metal foil, and a laminate thereof. A resin film is preferably used, because of its good surface smoothness.

Examples of the resin film include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the release film is generally from 5 to 200 μm, preferably from about 5 to about 100 μm. If necessary, the release film may be subjected to a release treatment and an antifouling treatment with a silicone, fluoride, long-chain alkyl, or fatty acid amide release agent, silica powder or the like, or subjected to an antistatic treatment of coating type, kneading and mixing type, vapor-deposition type, or the like. In particular, when the surface of the release film is appropriately subjected to a release treatment such as a silicone treatment, a long-chain alkyl treatment, or a fluorine treatment, the releasability from the pressure-sensitive adhesive layer can be further increased.

The transparent resin film substrate to be used may be, but not limited to, various transparent resin films. The resin film is generally formed of a monolayer film. Examples of the material for the transparent resin film substrate include polyester resins such as polyethylene terephthalate and polyethylene naphthalate, acetate resins, polyethersulfone resins, polycarbonate resins, polyamide resins, polyimide resins, polyolefin resins, (meth)acrylic resins, polyvinyl chloride resins, polyvinylidene chloride resins, polystyrene resins, polyvinyl alcohol resins, polyarylate resins, and polyphenylene sulfide resins. In particular, polyester resins, polyimide resins, and polyethersulfone resins are preferred.

The film substrate preferably has a thickness of 15 to 200 μm, more preferably 25 to 188 μm.

When the pressure-sensitive adhesive layer of the invention for a transparent conductive layer is made from the water-dispersible pressure-sensitive adhesive composition containing the water-soluble basic component, the content of the basic component is preferably controlled to 2,500 ng or less, more preferably 10 to 1,500 ng, even more preferably 10 to 750 ng, per 1 cm² of the pressure-sensitive adhesive layer. If the content of the water-soluble basic component is more than 2,500 ng, a polarizing plate used as the optical film may have a reduced degree of polarization, which may tend to have an adverse effect on the optical properties.

The amount of the water-soluble basic component determined by the measurement of the pressure-sensitive adhesive layer can be controlled by controlling the amount of the water-soluble basic component added to the aqueous dispersion in the process of preparing the water-dispersible acryl-based pressure-sensitive adhesive, by controlling the drying conditions in the process of applying and drying the water-dispersible acryl-based pressure-sensitive adhesive, or by controlling the thickness of the pressure-sensitive adhesive layer.

After the pressure-sensitive adhesive layer of the invention is formed on the resin film substrate to form a pressure-sensitive adhesive layer-attached resin film, a transparent conductive thin coating may be further formed on the side of the resin film substrate opposite to its side in contact with the pressure-sensitive adhesive layer. The resulting product can be used as an electrode for touch panel applications.

3. Pressure-Sensitive Adhesive Layer-Attached Optical Film

The pressure-sensitive adhesive layer-attached optical film of the invention includes an optical film and the pressure-sensitive adhesive layer for a transparent conductive layer, wherein the pressure-sensitive adhesive layer is formed on one surface of the optical film. Even when bonded directly to a transparent conductive thin coating made of a metal oxide, the pressure-sensitive adhesive layer-attached optical film makes it possible to suppress the corrosion of the transparent conductive thin coating because it has the pressure-sensitive adhesive layer of the invention.

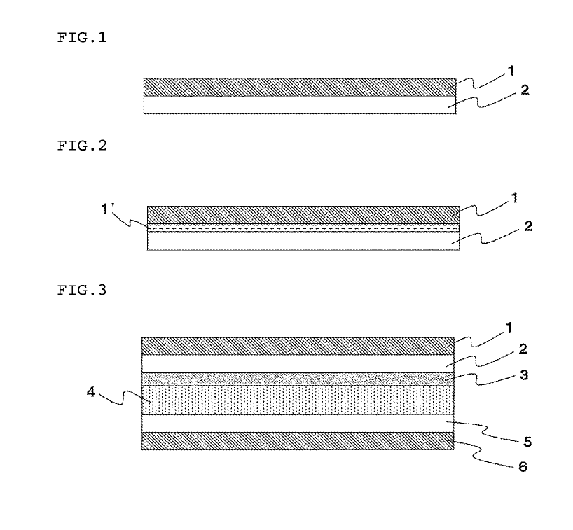

The pressure-sensitive adhesive layer-attached optical film of the invention will be described in detail with reference to FIG. 1. It will be understood that FIG. 1 shows a non-limiting example of the pressure-sensitive adhesive layer-attached optical film of the invention.

The pressure-sensitive adhesive layer-attached optical film of the invention (see FIG. 1) includes an optical film 1 and a pressure-sensitive adhesive layer 2 for a transparent conductive layer (hereinafter also referred to as the pressure-sensitive adhesive layer 2), wherein the pressure-sensitive adhesive layer 2 is provided on one surface of the optical film 1.

The optical film 1 used in the pressure-sensitive adhesive layer-attached optical film of the invention may be of any type used in forming image display devices such as liquid crystal display devices. For example, the optical film 1 may be a polarizing plate. The polarizing plate may generally include a polarizer and a transparent protective film or films provided on one or both sides of the polarizer.

A polarizer is, but not limited to, various kinds of polarizer may be used. As a polarizer, for example, a film that is uniaxially stretched after having dichromatic substances, such as iodine and dichromatic dye, absorbed to hydrophilic polymer films, such as polyvinyl alcohol-based film, partially formalized polyvinyl alcohol-based film, and ethylene-vinyl acetate copolymer-based partially saponified film; polyene-based alignment films, such as dehydrated polyvinyl alcohol and dehydrochlorinated polyvinyl chloride, etc. may be mentioned. In these, a polyvinyl alcohol-based film on which dichromatic materials such as iodine, is absorbed and aligned after stretched is suitably used. Thickness of polarizer is, but not limited to, generally from about 5 μm to about 80 μm.

A polarizer that is uniaxially stretched after a polyvinyl alcohol-based film dyed with iodine is obtained by stretching a polyvinyl alcohol film by 3 to 7 times the original length, after dipped and dyed in aqueous solution of iodine. If needed the film may also be dipped in aqueous solutions containing boric acid and potassium iodide, which may include zinc sulfate, zinc chloride. Furthermore, before dyeing, the polyvinyl alcohol-based film may be dipped in water and rinsed if needed. By rinsing polyvinyl alcohol-based film with water, effect of preventing un-uniformity, such as unevenness of dyeing, is expected by making polyvinyl alcohol-based film swelled in addition that also soils and blocking inhibitors on the polyvinyl alcohol-based film surface may be washed off. Stretching may be applied after dyed with iodine or may be applied concurrently, or conversely dyeing with iodine may be applied after stretching. Stretching is applicable in aqueous solutions containing boric acid and potassium iodide, and in water bath.

The transparent protective film or films on one or both sides of the polarizer are preferably made of a material having a high level of transparency, mechanical strength, thermal stability, water barrier properties, isotropy, and other properties. Examples of such a material include polyester polymers such as polyethylene terephthalate and polyethylene naphthalate, cellulose polymers such as diacetyl cellulose and triacetyl cellulose, acryl-based polymers such as polymethyl methacrylate, styrene polymers such as polystyrene and acrylonitrile-styrene copolymers (AS resins), polycarbonate polymers, etc. Examples of polymers that may be used to form the transparent protective films also include polyolefin polymers such as polyethylene, polypropylene, cyclo- or norbornene-structure-containing polyolefin, and ethylene-propylene copolymers, vinyl chloride polymers, amide polymers such as nylon and aromatic polyamide, imide polymers, sulfone polymers, polyether sulfone polymers, polyether ether ketone polymers, polyphenylene sulfide polymers, vinyl alcohol polymers, vinylidene chloride polymers, vinyl butyral polymers, arylate polymers, polyoxymethylene polymers, epoxy polymers, or any blends of the above polymers. The transparent protective film may also be a layer formed by curing a curable resin such as a thermosetting or ultraviolet-curable resin such as an acrylic, urethane, acrylic urethane, epoxy, or silicone resin.

The thickness of the protective film may be determined as appropriate. Generally, the thickness of the protective film is from about 1 to about 500 μm in view of strength, workability such as handleability, and thin film formability.

The protective film is preferably made of a cellulose polymer such as triacetyl cellulose in view of polarizing properties, durability, and other properties. A triacetyl cellulose film is particularly preferred. When protective films are provided on both sides of the polarizer, protective films made of the same polymer material or different polymer materials may be used on the front and back sides. The polarizer and the protective film are generally bonded with a water-based adhesive or the like interposed therebetween. Examples of the water-based adhesive include isocyanate adhesives, polyvinyl alcohol-based adhesives, gelatin-based adhesives, vinyl-based latex-based adhesives, water-based polyurethane adhesives, and water-based polyester adhesives.

The surface of the transparent protective film opposite to its surface to be bonded to the polarizer may have undergone the formation of a hard coat layer, an anti-reflection treatment, an anti-sticking treatment, or a treatment for diffusion or antiglare properties.

Examples of the optical film other than polarizing plates include a reflector, a transflector, a retardation plate (including a wavelength plate such as a half or quarter wavelength plate), a viewing angle compensation film, a brightness enhancement film, and any other optical layer that can be used to form a liquid crystal display device or the like. They may be used alone as the optical film, or one or more layers of any of them may be used together with the polarizing plate to form a laminate for practical use.

The optical film may be subjected to an activation treatment. The activation treatment may be performed using various methods such as a corona treatment, a low-pressure UV treatment, and a plasma treatment.

The pressure-sensitive adhesive layer is formed on the optical film by the method described above.

When the surface of the pressure-sensitive adhesive layer is exposed, the pressure-sensitive adhesive layer may be protected by a release film (separator) until it is actually used. Examples of the release film include those listed above. When a release film is used as the substrate on which the pressure-sensitive adhesive layer is formed, the optical film may be bonded to the pressure-sensitive adhesive layer on the release film, so that the release film can be used as it is for the pressure-sensitive adhesive layer of the pressure-sensitive adhesive layer-attached optical film, which can simplify the process.

An anchor layer 1′ (see FIG. 2) may also be provided between the optical film 1 and the pressure-sensitive adhesive layer 2 for a transparent conductive layer. Examples of the material used to form the anchor layer include, but are not limited to, various polymers, metal oxide sols, and silica sols. In particular, polymers are preferably used. The polymers to be used may be of any of solvent-soluble, water-dispersible, and water-soluble types.

Examples of the polymers include polyurethane resins, polyester resins, acrylic resins, polyether resins, cellulose resins, polyvinyl alcohol resins, polyvinylpyrrolidone, and polystyrene resins. In particular, polyurethane resins, polyester resins, and acrylic resins are preferred. Any appropriate crosslinking agent may be added to any of these resins. Besides the above, one or more binder components may be appropriately used depending on the intended use.

When the anchor layer is made from a water-dispersible material, a water-dispersible polymer may be used. The water-dispersible polymer may be in the form of an emulsion, which is prepared by emulsifying polyurethane, polyester, or any other resin with an emulsifying agent, or may be a self-emulsified resin prepared by introducing a water-dispersible anionic, cationic, or nonionic group into the resin.

The anchor agent may contain an antistatic agent. The antistatic agent may be of any type as long as it can impart electrical conductivity. Examples thereof include ionic surfactants, conductive polymers, metal oxides, carbon black, and carbon nanomaterials. In particular, conductive polymers are preferred, and water-dispersible conductive polymers are more preferred.

Examples of the water-soluble conductive polymer include polyaniline sulfonic acid (with a polystyrene-equivalent weight average molecular weight of 150,000, manufactured by MITSUBISHI RAYON CO., LTD.) and the like. Examples of the water-dispersible conductive polymer include polythiophene conductive polymers (Denatron series manufactured by Nagase ChemteX Corporation) and the like.

The content of the antistatic agent may be 70 parts by weight or less, preferably 50 parts by weight or less, based on 100 parts by weight of the polymers for use for the anchor agent. In view of the antistatic effect, the content is preferably 10 parts by weight or more, more preferably 20 parts by weight or more.

The thickness of the anchor layer is preferably, but not limited to, 5 to 300 nm.

The anchor layer may be formed by any conventionally known method. When the anchor layer is formed, the optical film may be subjected to an activation treatment. The activation treatment may be performed using various methods such as a corona treatment, a low-pressure UV treatment, and a plasma treatment.

The method described above may be used to form the pressure-sensitive adhesive layer on the anchor layer on the optical film.

4. Liquid Crystal Display Device

Even when the pressure-sensitive adhesive layer of the pressure-sensitive adhesive layer-attached optical film of the invention is bonded directly to a transparent conductive thin coating, the pressure-sensitive adhesive layer-attached optical film of the invention makes it possible to suppress the corrosion of the transparent conductive thin coating. Therefore, the pressure-sensitive adhesive layer-attached optical film of the invention may also be bonded to a liquid crystal cell having a transparent conductive thin coating. Therefore, the pressure-sensitive adhesive layer-attached optical film of the invention is suitable for use in a variety of liquid crystal display devices.

Particularly in some liquid crystal display devices using an IPS liquid crystal cell, a transparent conductive thin coating is formed as an antistatic layer on the opposite side of the transparent substrate of the liquid crystal cell from its side in contact with the liquid crystal layer. In such liquid crystal display devices, the pressure-sensitive adhesive layer of the pressure-sensitive adhesive layer-attached optical film of the invention may be bonded to the transparent conductive thin coating, so that the transparent conductive thin coating as the antistatic layer can be advantageously prevented from corroding.

FIG. 3 shows an example of a liquid crystal display device formed using the pressure-sensitive adhesive layer-attached optical film of the invention. The liquid crystal display device of FIG. 3 includes an optical film 1, a pressure-sensitive adhesive layer 2 for a transparent conductive layer, a transparent conductive layer 3, a liquid crystal cell 4, a pressure-sensitive adhesive layer 5, and an optical film 6. It will be understood that the liquid crystal display device of the invention is not limited to this type and may include any of various layers suitable for use in the liquid crystal display device with these features.

The optical film 1 and the pressure-sensitive adhesive layer 2 for a transparent conductive layer correspond to the pressure-sensitive adhesive layer-attached optical film. Examples of the optical film 6 may be the same as those of the optical film 1.

The liquid crystal cell may be of any type such as TN type, STN type, n type, VA type, or IPS type. For the reason suggested above, the invention is highly effective particularly when an IPS liquid crystal cell is used.

The pressure-sensitive adhesive layer 5 may be the pressure-sensitive adhesive layer of the invention or any pressure-sensitive adhesive layer commonly used in liquid crystal image display devices. For example, a pressure-sensitive adhesive including an acryl-based polymer, a silicone polymer, polyester, polyurethane, polyether, a fluoropolymer, a synthetic rubber polymer, or the like as a base polymer may be used to form the pressure-sensitive adhesive layer. In particular, an acrylic pressure-sensitive adhesive having a high level of optical transparency, weather resistance, and heat resistance and a suitable level of wettability and adhesive properties such as cohesion and adhesion is preferably used.

The material used to form the transparent conductive layer 3 on the liquid crystal cell is typically, but not limited to, a metal oxide. The metal oxide is preferably indium oxide doped with tin oxide. Such a metal oxide preferably contains 80 to 99% by weight of indium oxide and 1 to 20% by weight of tin oxide.

The thickness of the transparent conductive layer 3 is preferably, but not limited to, 10 nm or more. If the thickness is too large, a reduction in transparency and so on may occur. Therefore, the thickness is preferably from 15 to 35 nm, more preferably from 20 to 30 nm. If the thickness is less than 15 nm, the surface electric resistance may be too high, and it may be difficult to form a continuous coating film. If the thickness is more than 35 nm, a reduction in transparency may occur.

The transparent conductive layer 3 may be formed using known conventional methods, while the methods are not particularly limited. Examples of such methods include vacuum deposition, sputtering, and ion plating. Any appropriate method may be used depending on the required thickness of the layer.

In the process of forming the transparent conductive layer 3, an undercoat layer may also be provided. The undercoat layer may be made of an inorganic material, an organic material, or a mixture of inorganic and organic materials. Examples of the inorganic material include NaF (1.3), Na₃AlF₆ (1.35), LiF (1.36), MgF₂ (1.38), CaF₂ (1.4), BaF₂ (1.3), SiO₂ (1.46), LaF₃ (1.55), CeF₃ (1.63), and Al₂O₃ (1.63), wherein each number inside the parentheses is the refractive index of each material. In particular, SiO₂, MgF₂, Al₂O₃, or the like is preferably used. In particular, SiO₂ is preferred. Besides the above, a complex oxide containing about 10 to about 40 parts by weight of cerium oxide and about 0 to about 20 parts by weight of tin oxide based on the indium oxide may also be used.

The undercoat layer made of an inorganic material may be form with a dry process such as vacuum deposition, sputtering or ion plating, a wet process (coating process), or the like. SiO₂ is preferably used as the inorganic material to form the undercoat layer as described above. In a wet process, a silica sol or the like may be applied to form a SiO₂ film.

Besides the components described above, the liquid crystal display device of the invention may also include any of various layers commonly used in liquid crystal display devices, such as any optical compensation layers and adhesive layers, between the respective layers shown in FIG. 3 and/or on the outside of the layer shown in FIG. 3.

### EXAMPLES

Hereinafter, the invention will be more specifically described with reference to examples, which however are not intended to limit the gist of the invention. In each example, “parts” and “%” are all by weight.

### Example 1

### Preparation of Aqueous Dispersion

To a vessel were added 1,000 parts of butyl acrylate, 70 parts of acrylic acid, 28 parts of mono[poly(propylene oxide)methacrylate]phosphate ester (5.0 in average number of polymerized propylene oxide units), and 0.69 parts of 3-methacryloyloxypropyl-triethoxysilane (KBM-503 manufactured by Shin-Etsu Chemical Co., Ltd.) as raw materials and mixed to form a monomer mixture. Subsequently, 10 parts of ELEMINOL JS-20 (manufactured by Sanyo Chemical Industries, Ltd.) (4 parts on solid basis) as a reactive surfactant and 360 parts of ion exchanged water were added to 600 parts of the monomer mixture prepared with the above composition. The mixture was stirred at 7,000 rpm for 3 minutes with a homogenizer (manufactured by PRIMIX Corporation) to form a monomer emulsion.

Subsequently, 200 parts of the prepared monomer emulsion and 350 parts of ion exchanged water were added to a reaction vessel equipped with a condenser tube, a nitrogen introducing tube, a thermometer, a dropping funnel, and a stirring blade. Subsequently, after the air in the reaction vessel was sufficiently replaced with nitrogen gas, 0.1 parts of ammonium persulfate was added to the reaction vessel. The mixture was subjected to polymerization at 65° C. for 2 hours. Subsequently, the remaining part of the monomer emulsion was added dropwise over 3 hours to the reaction vessel and then subjected to polymerization for 3 hours. The mixture was then further subjected to polymerization at 75° C. for 5 hours under nitrogen purge, so that an aqueous dispersion (emulsion) with a solid concentration of 42% was obtained. The (mech)acryl-based polymer in the aqueous dispersion (emulsion) had an average particle size of 0.10 μm.

(Preparation of Water-Dispersible Pressure-Sensitive Adhesive Composition)

Subsequently, 3 parts of ammonia water with a concentration of 10% was added to 100 parts by weight of the aqueous dispersion (emulsion) to form a water-dispersible pressure-sensitive adhesive composition.

(Formation of Pressure-Sensitive Adhesive Layer for Transparent Conductive Layer)

The water-dispersible pressure-sensitive adhesive composition was applied to a release film (Diafoil MRF-38 (polyethylene terephthalate substrate) manufactured by Mitsubishi Plastics, Inc.) with an applicator so that a 25-μm-thick coating would be formed after drying. The coating was then dried at 150° C. for 10 minutes in a hot air circulating oven to form a pressure-sensitive adhesive layer for a transparent conductive layer (a pressure-sensitive adhesive layer-attached release film).

(Preparation of Pressure-Sensitive Adhesive Layer-Attached Polarizing Plate)

An 80-μm-thick polyvinyl alcohol film was stretched 5 times in an aqueous iodine solution at 40° C. and then dried at 50° C. for 4 minutes to obtain a polarizer. Triacetyl cellulose films were bonded to both sides of the polarizer using a polyvinyl alcohol-based adhesive, so that a polarizing plate was obtained.

EPOCROS WS-700 (oxazoline group-containing acryl-based polymer, manufactured by NIPPON SHOKUBAI CO., LTD.) was diluted with a mixed solution of water and isopropyl alcohol (IPA) (volume ratio: water/IPA=1/1) to a solid concentration of 0.25% by weight, so that an anchor coat solution (anchor agent) was obtained. The anchor coat solution was applied to one side of the polarizing plate with Mayer Bar #5 so that a 50-nm-thick coating would be formed after drying. The coating was dried at 40° C. for 3 minutes to form an anchor layer.

The pressure-sensitive adhesive layer of the pressure-sensitive adhesive layer-attached release film obtained by forming the pressure-sensitive adhesive layer for a transparent conductive layer was bonded to the surface of the anchor layer to form a pressure-sensitive adhesive layer-attached polarizing plate.

### Example 2

A pressure-sensitive adhesive layer-attached polarizing plate was prepared as in Example 1, except that the added amount of the reactive surfactant was changed from 4 parts to 13 parts in the preparation of the aqueous dispersion.

### Example 3

A pressure-sensitive adhesive layer-attached polarizing plate was prepared as in Example 2, except that 0.6 parts of a phosphate group-containing ester (PHOSPHANOL SM-172 (trade name) manufactured by TOHO Chemical Industry Co., Ltd.) was added to 600 parts of the monomer mixture in the preparation of the aqueous dispersion.

### Example 4

A pressure-sensitive adhesive layer-attached polarizing plate was prepared as in Example 3, except that the added amount of the phosphate group-containing ester was changed from 0.6 parts to 6 parts in the preparation of the aqueous dispersion.

### Example 5

A pressure-sensitive adhesive layer-attached polarizing plate was prepared as in Example 3, except that the phosphate group-containing ester was changed from PHOSPHANOL SM-172 (trade name) manufactured by TOHO Chemical Industry Co., Ltd. to PHOSPHANOL BH-650 (trade name) manufactured by TOHO Chemical Industry Co., Ltd in the preparation of the aqueous dispersion.

### Example 6

A pressure-sensitive adhesive layer-attached polarizing plate was prepared as in Example 1, except that the added amount of the reactive surfactant was changed from 4 parts to 13 parts in the preparation of the aqueous dispersion, the added amount of the ammonia water was changed from 3 parts to 0.5 parts in the preparation of the water-dispersible pressure-sensitive adhesive composition, and the drying conditions were changed from 150° C. and 10 minutes to 135° C. and 2 minutes in the formation of the pressure-sensitive adhesive layer for a transparent conductive layer.

### Example 7

A pressure-sensitive adhesive layer-attached polarizing plate was prepared as in Example 1, except that the added amount of the reactive surfactant was changed from 4 parts to 13 parts in the preparation of the aqueous dispersion, no ammonia water was added in the preparation of the water-dispersible pressure-sensitive adhesive composition, and the drying conditions were changed from 150° C. and 10 minutes to 135° C. and 2 minutes in the formation of the pressure-sensitive adhesive layer for a transparent conductive layer.

### Example 8

A pressure-sensitive adhesive layer-attached polarizing plate was prepared as in Example 1, except that the added amount of the reactive surfactant was changed from 4 parts to 30 parts in the preparation of the aqueous dispersion.

### Example 9

A pressure-sensitive adhesive layer-attached polarizing plate was prepared as in Example 1, except that the reactive surfactant was changed from ELEMINOL JS-20 (manufactured by Sanyo Chemical Industries, Ltd.) to LATEMUL S-180A (manufactured by Kao Corporation) in the preparation of the aqueous dispersion.

### Example 10

A pressure-sensitive adhesive layer-attached polarizing plate was prepared as in Example 1, except that the reactive surfactant was changed from 4 parts of ELEMINOL JS-20 (manufactured by Sanyo Chemical Industries, Ltd.) to 13 parts of LATEMUL S-180A (manufactured by Kao Corporation) in the preparation of the aqueous dispersion.

### Example 11

A pressure-sensitive adhesive layer-attached polarizing plate was prepared as in Example 1, except that the reactive surfactant was changed from 4 parts of ELEMINOL JS-20 (manufactured by Sanyo Chemical Industries, Ltd.) to 13 parts of LATEMUL S-180A (manufactured by Kao Corporation) in the preparation of the aqueous dispersion, no ammonia water was added in the preparation of the water-dispersible pressure-sensitive adhesive composition, and the drying conditions were changed from 150° C. and 10 minutes to 135° C. and 2 minutes in the formation of the pressure-sensitive adhesive layer for a transparent conductive layer.

### Example 12

A pressure-sensitive adhesive layer-attached polarizing plate was prepared as in Example 1, except that the reactive surfactant was changed from 4 parts of ELEMINOL JS-20 (manufactured by Sanyo Chemical Industries, Ltd.) to 13 parts of LATEMUL S-180A (manufactured by Kao Corporation) in the preparation of the aqueous dispersion, the added amount of ammonia water was changed from 3 parts to 0.5 parts in the preparation of the water-dispersible pressure-sensitive adhesive composition, and the drying conditions were changed from 150° C. and 10 minutes to 135° C. and 2 minutes in the formation of the pressure-sensitive adhesive layer for a transparent conductive layer.

### Example 13

A pressure-sensitive adhesive layer-attached polarizing plate was prepared as in Example 1, except that the reactive surfactant was changed from 4 parts of ELEMINOL JS-20 (manufactured by Sanyo Chemical Industries, Ltd.) to 30 parts of LATEMUL S-180A (manufactured by Kao Corporation) in the preparation of the aqueous dispersion.

### Comparative Example 1

A pressure-sensitive adhesive layer-attached polarizing plate was prepared as in Example 1, except that the reactive surfactant was changed from 4 parts of ELEMINOL JS-20 (manufactured by Sanyo Chemical Industries, Ltd.) to 13 parts of LATEMUL PD-104 (manufactured by Kao Corporation) in the preparation of the aqueous dispersion.

### Comparative Example 2

A pressure-sensitive adhesive layer-attached polarizing plate was prepared as in Comparative Example 1, except that 0.6 parts of a phosphate group-containing ester (PHOSPHANOL SM-172 (trade name) manufactured by TOHO Chemical Industry Co., Ltd.) was added to 600 parts of the monomer mixture in the preparation of the aqueous dispersion.

### Comparative Example 3

A pressure-sensitive adhesive layer-attached polarizing plate was prepared as in Example 1, except that the reactive surfactant was changed from 4 parts of ELEMINOL JS-20 (manufactured by Sanyo Chemical Industries, Ltd.) to 13 parts of LATEMUL PD-104 (manufactured by Kao Corporation) in the preparation of the aqueous dispersion, no ammonia water was added in the preparation of the water-dispersible pressure-sensitive adhesive composition, and the drying conditions were changed from 150° C. and 10 minutes to 135° C. and 2 minutes in the formation of the pressure-sensitive adhesive layer for a transparent conductive layer.

### Comparative Example 4

A pressure-sensitive adhesive layer-attached polarizing plate was prepared as in Example 1, except that the reactive surfactant was changed from 4 parts of ELEMINOL JS-20 (manufactured by Sanyo Chemical Industries, Ltd.) to 13 parts of ADEKA REASOAP SE-10 (manufactured by ADEKA CORPORATION) in the preparation of the aqueous dispersion.

### Comparative Example 5

A pressure-sensitive adhesive layer-attached polarizing plate was prepared as in Example 1, except that the reactive surfactant was changed from 4 parts of ELEMINOL JS-20 (manufactured by Sanyo Chemical Industries, Ltd.) to 13 parts of ADEKA REASOAP SE-10 (manufactured by ADEKA CORPORATION) in the preparation of the aqueous dispersion, no ammonia water was added in the preparation of the water-dispersible pressure-sensitive adhesive composition, and the drying conditions were changed from 150° C. and 10 minutes to 135° C. and 2 minutes in the formation of the pressure-sensitive adhesive layer for a transparent conductive layer.

### Comparative Example 6

A pressure-sensitive adhesive layer-attached polarizing plate was prepared as in Example 1, except that the reactive surfactant was changed from 4 parts of ELEMINOL JS-20 (manufactured by Sanyo Chemical Industries, Ltd.) to 13 parts of Antox MS-60 (manufactured by NIPPON NYUKAZAI CO., LTD.) in the preparation of the aqueous dispersion.

### Comparative Example 7

A pressure-sensitive adhesive layer-attached polarizing plate was prepared as in Example 1, except that the reactive surfactant was changed from 4 parts of ELEMINOL JS-20 (manufactured by Sanyo Chemical Industries, Ltd.) to 13 parts of Antox MS-60 (manufactured by NIPPON NYUKAZAI CO., LTD.) in the preparation of the aqueous dispersion, no ammonia water was added in the preparation of the water-dispersible pressure-sensitive adhesive composition, and the drying conditions were changed from 150° C. and 10 minutes to 135° C. and 2 minutes in the formation of the pressure-sensitive adhesive layer for a transparent conductive layer.

### Comparative Example 8

A pressure-sensitive adhesive layer-attached polarizing plate was prepared as in Example 1, except that 4 parts of ELEMINOL JS-20 (manufactured by Sanyo Chemical Industries, Ltd.) as a reactive surfactant was changed to 13 parts of LATEMUL E-150 (manufactured by Kao Corporation) as a non-reactive surfactant in the preparation of the aqueous dispersion.

### Comparative Example 9

A pressure-sensitive adhesive layer-attached polarizing plate was prepared as in Example 1, except that 4 parts of ELEMINOL JS-20 (manufactured by Sanyo Chemical Industries, Ltd.) as a reactive surfactant was changed to 13 parts of EMAL 2F-30 (manufactured by Kao Corporation) as a non-reactive surfactant in the preparation of the aqueous dispersion.

### Comparative Example 10

A pressure-sensitive adhesive layer-attached polarizing plate was prepared as in Example 1, except that the reactive surfactant was changed from 4 parts of ELEMINOL JS-20 (manufactured by Sanyo Chemical Industries, Ltd.) to 13 parts of LATEMUL PD-104 (manufactured by Kao Corporation) in the preparation of the aqueous dispersion and the drying conditions were changed from 150° C. and 10 minutes to 135° C. and 2 minutes in the formation of the pressure-sensitive adhesive layer for a transparent conductive layer.

### Comparative Example 11

A pressure-sensitive adhesive layer-attached polarizing plate was prepared as in Example 1, except that the reactive surfactant was changed from 4 parts of ELEMINOL JS-20 (manufactured by Sanyo Chemical Industries, Ltd.) to 13 parts of LATEMUL PD-104 (manufactured by Kao Corporation) in the preparation of the aqueous dispersion and the drying conditions were changed from 150° C. and 10 minutes to 100° C. and 2 minutes in the formation of the pressure-sensitive adhesive layer for a transparent conductive layer.

The surfactants used in Comparative Examples 1 to 8, 10, and 11 all have at least four oxyalkylene repeating units.

TABLE 1

| | Pressure-sensitive adhesive composition | | | | | | | | | | |
|---|---|---|---|---|---|---|---|---|---|---|---|
| | | | | | | | Ammonia | | | | |
| | Surfactant | | | | Phosphate ester | | water | | | | |
| | | Presence | Presence or | Added | | Added | Added | Pressure-sensitive adhesive layer | | | |
| | | or | absence of | amount | | amount | amount | Drying conditions | | Ammonium | Thick- |
| | Trade | absence of | oxyalkylene | (parts by | Trade | (parts by | (parts by | Temperature | Time | component | ness |
| | name | reactive group | repeating unit | weight) | name | weight) | weight) | (° C.) | (minutes) | (ng/cm²) | (μm) |
| Example 1 | ELEMINOL | Present | Absent | 4 | — | 0 | 3 | 150 | 10 | 420 | 25 |
| | JS-20 | | | | | | | | | | |
| Example 2 | ELEMINOL | Present | Absent | 13 | — | 0 | 3 | 150 | 10 | 440 | 25 |
| | JS-20 | | | | | | | | | | |
| Example 3 | ELEMINOL | Present | Absent | 13 | SM-72 | 0.6 | 3 | 150 | 10 | 460 | 25 |
| | JS-20 | | | | | | | | | | |
| Example 4 | ELEMINOL | Present | Absent | 13 | SM-172 | 6 | 3 | 150 | 10 | 480 | 25 |
| | JS-20 | | | | | | | | | | |
| Example 5 | ELEMINOL | Present | Absent | 13 | BK-650 | 0.6 | 3 | 150 | 10 | 480 | 25 |
| | JS-20 | | | | | | | | | | |
| Example 6 | ELEMINOL | Present | Absent | 13 | — | 0 | 0.5 | 135 | 2 | 390 | 25 |
| | JS-20 | | | | | | | | | | |
| Example 7 | ELEMINOL | Present | Absent | 13 | — | 0 | 0 | 135 | 2 | 0 | 25 |
| | JS-20 | | | | | | | | | | |
| Example 8 | ELEMINOL | Present | Absent | 30 | — | 0 | 3 | 130 | 10 | 520 | 25 |
| | JS-20 | | | | | | | | | | |
| Example 9 | LATEMOL | Present | Absent | 4 | — | 0 | 3 | 150 | 10 | 690 | 25 |
| | S-180A | | | | | | | | | | |
| Example 10 | LATEMOL | Present | Absent | 13 | — | 0 | 3 | 150 | 10 | 710 | 25 |
| | S-180A | | | | | | | | | | |
| Example 11 | LATEMOL | Present | Absent | 13 | — | 0 | 0 | 135 | 2 | 0 | 25 |
| | S-180A | | | | | | | | | | |
| Example 12 | LATEMOL | Present | Absent | 13 | — | 0 | 0.6 | 130 | 2 | 610 | 25 |
| | S-180A | | | | | | | | | | |
| Example 13 | LATEMOL | Present | Absent | 20 | — | 0 | 3 | 150 | 10 | 700 | 25 |
| | S-180A | | | | | | | | | | |
| Comparative | LATEMOL | Present | Present | 13 | — | 0 | 3 | 150 | 10 | 620 | 25 |
| Example 1 | PD-104 | | | | | | | | | | |
| Comparative | LATEMOL | Present | Present | 13 | SM-172 | 0.6 | 3 | 150 | 10 | 680 | 25 |
| Example 2 | PD-104 | | | | | | | | | | |
| Comparative | LATEMOL | Present | Present | 13 | — | 0 | 0 | 135 | 2 | 0 | 25 |
| Example 3 | PD-104 | | | | | | | | | | |
| Comparative | ADEKA | Present | Present | 13 | — | 0 | 3 | 130 | 10 | 680 | 25 |
| Example 4 | REASOAP | | | | | | | | | | |
| | SE-10 | | | | | | | | | | |
| Comparative | ADEKA | Present | Present | 13 | — | 0 | 0 | 135 | 2 | 0 | 25 |
| | REASOAP | | | | | | | | | | |
| Example 5 | SE-10 | | | | | | | | | | |
| Comparative | Antox MS-60 | Present | Present | 13 | — | 0 | 3 | 150 | 10 | 750 | 25 |
| Example 6 | | | | | | | | | | | |
| Comparative | Antox MS-60 | Present | Present | 13 | — | 0 | 0 | 150 | 2 | 0 | 25 |
| Example 7 | | | | | | | | | | | |
| Comparative | LATEMOL | Absent | Present | 13 | — | 0 | 3 | 135 | 10 | 110 | 25 |
| Example 8 | E-150 | | | | | | | | | | |
| Comparative | EMAL 2F-30 | Absent | Absent | 13 | — | 0 | 3 | 130 | 10 | 120 | 25 |
| Example 9 | | | | | | | | | | | |
| Comparative | LATEMOL | Present | Present | 13 | — | 0 | 3 | 135 | 2 | 1400 | 25 |
| Example 10 | PD-104 | | | | | | | | | | |
| Comparative | LATEMOL | Present | Present | 13 | — | 0 | 3 | 100 | 2 | 2600 | 25 |
| Example 11 | PD-104 | | | | | | | | | | |

The thickness, polarization properties, and corrosive properties of the pressure-sensitive adhesive layer for a transparent conductive layer, obtained in each of the examples and the comparative examples, were evaluated as described below. The results are shown in Tables 1 and 2.

<Method for Measuring the Thickness of Pressure-Sensitive Adhesive Layer>

The thickness of the pressure-sensitive adhesive layer was determined by measuring, with a dial gauge, the total thickness of the release film and the pressure-sensitive adhesive layer for a transparent conductive layer, formed on the release film, and then subtracting the thickness of the release film from the total thickness.

<Polarization Properties>

A sample of a size of 15 inches was cut from the pressure-sensitive adhesive layer-attached polarizing plate. The sample was bonded to a glass plate and then subjected to the measurement of the degree of polarization. The measured degree of polarization is called the initial degree (A) of polarization. The sample was allowed to stand for 500 hours in an environment at 80° C. and an environment at 60° C. and 90% R.H., respectively, and then subjected to the measurement of the degree of polarization in the same way. The measured degree of polarization is called the post-treatment degree (B) of polarization. The degree of polarization was measured with a spectrophotometer (DOT-3C manufactured by MURAKAMI COLOR RESEARCH LABORATORY). The change (A-B) in the degree of polarization was calculated from the initial degree (A) of polarization and the post-treatment degree (B) of polarization.

<Corrosion Resistance>

(Preparation of Film Having Crystalline ITO Thin Coating)

ELECRYSTA V270L-TFME manufactured by Nitto Denko Corporation was used, which was a film having a 22-nm-thick crystalline ITO thin coating. The film having the crystalline ITO thin coating was heat-treated at 140° C. for 90 minutes before subjected to an evaluation test. After the treatment, the ITO thin coating of the film was crystallized.

(Preparation of Film Having Non-Crystalline ITO Thin Coating)

ELECRYSTA P400L-TNME manufactured by Nitto Denko Corporation was used, which was a film having a 22-nm-thick non-crystalline ITO thin coating. The film having the non-crystalline ITO thin coating was heat-treated at 140° C. for 90 minutes before subjected to an evaluation test. After the treatment, the ITO thin coating of the film was amorphous.

A piece of 8 mm×8 mm was cut from the pressure-sensitive adhesive layer-attached release film obtained in each of the examples and the comparative examples. The pressure-sensitive adhesive layer surface of the cut piece was laminated to the ITO thin coating of the film (15 mm×15 mm), so that a laminate sample was obtained. The resistance of the ITO thin coating of the film in the sample was measured with a hall sensor (it is called the pre-test resistance). The sample was then allowed to stand for 500 hours in an atmosphere at 60° C. and 95% R.H. After the standing, the resistance of the ITO thin coating of the film in the sample was measured in the same way (it is called the post-test resistance). Using the measurement results, the rate of increase in the resistance between before and after the sample was allowed to stand in the above atmosphere was calculated from the following formula.

The rate (%) of increase in the resistance=(the post-test resistance/the pre-test resistance)×100

The lower the rate of increase in the resistance, the better the result. If the rate of increase in the resistance is 130% or less, then it can be determined that a satisfactory level of corrosion resistance is achieved.

◯: The rate of increase in the resistance is 130% or less.
x: The rate of increase in the resistance is more than 130%.

<Method for Measuring Ammonium Component>

Apiece of 9 cm×9 cm was cut from the pressure-sensitive adhesive layer-attached polarizing plate. After the release film was peeled off from the cut piece, the remaining part was subjected to boiling extraction in pure water at 120° C. for 1 hour. Ammonium ions in the extract were quantified by ion chromatography (DX-500 manufactured by Dionex Corporation). Five samples were measured, and the measured values were averaged. The average was converted into a value per 1 cm², which was determined as the ammonium component content.

TABLE 2

| | Polarization properties | | | | |
|---|---|---|---|---|---|
| | | Polar- | | | |
| | Polar- | ization | | | |
| | ization | degree | | | |
| | degree | (%) | Corrosion resistance | | |
| | (%) | (60° C., | | Increase | |
| | (80° C., | 90% R.H., | | rate | Eval- |
| | 500 hours) | 500 hours) | ITO type | (%) | uation |
| Example 1 | 0.12 | 0.035 | Crystalline | 113 | ◯ |
| Example 2 | 0.13 | 0.036 | Crystalline | 118 | ◯ |
| | | | Non-crystalline | 121 | ◯ |
| Example 3 | 0.15 | 0.031 | Crystalline | 103 | ◯ |
| | | | Non-crystalline | 111 | ◯ |
| Example 4 | 0.14 | 0.033 | Crystalline | 105 | ◯ |
| Example 5 | 0.14 | 0.033 | Crystalline | 103 | ◯ |
| Example 6 | 0.12 | 0.035 | Crystalline | 118 | ◯ |
| Example 7 | 0.11 | 0.034 | Crystalline | 123 | ◯ |
| | | | Non-crystalline | 125 | ◯ |
| Example 8 | 0.13 | 0.036 | Crystalline | 121 | ◯ |
| Example 9 | 0.12 | 0.035 | Crystalline | 118 | ◯ |
| Example 10 | 0.13 | 0.035 | Crystalline | 122 | ◯ |
| Example 11 | 0.10 | 0.033 | Crystalline | 125 | ◯ |
| Example 12 | 0.11 | 0.035 | Crystalline | 126 | ◯ |
| Example 13 | 0.13 | 0.037 | Crystalline | 126 | ◯ |
| Comparative | 0.13 | 0.036 | Crystalline | 422 | X |
| Example 1 | | | Non-crystalline | 860 | X |
| Comparative | 0.14 | 0.032 | Crystalline | 350 | X |
| Example 2 | | | | | |
| Comparative | 0.11 | 0.035 | Crystalline | 452 | X |
| Example 3 | | | | | |
| Comparative | 0.13 | 0.036 | Crystalline | 457 | X |
| Example 4 | | | | | |
| Comparative | 0.11 | 0.034 | Crystalline | 482 | X |
| Example 5 | | | | | |
| Comparative | 0.14 | 0.037 | Crystalline | 413 | X |
| Example 6 | | | | | |
| Comparative | 0.10 | 0.034 | Crystalline | 439 | X |
| Example 7 | | | | | |
| Comparative | 0.13 | 0.036 | Crystalline | 373 | X |
| Example 8 | | | | | |
| Comparative | 0.14 | 0.036 | Crystalline | 365 | X |
| Example 9 | | | | | |
| Comparative | 0.15 | 0.051 | Crystalline | 115 | ◯ |
| Example 10 | | | | | |
| Comparative | 0.20 | 0.098 | Crystalline | 114 | ◯ |
| Example 11 | | | | | |

It is apparent that regardless of what amount of ammonium is added or whether the ITO is crystalline, the pressure-sensitive adhesive layer-attached polarizing plate of each of the examples makes it possible to suppress the corrosion of the ITO thin coating and also has good polarization properties. In contrast, the corrosion resistance is significantly low in the cases of Comparative Examples 1 to 8 where the reactive surfactant used has at least four oxyalkylene repeating units and the ammonium component content of the pressure-sensitive adhesive layer is substantially the same as that in the examples. The corrosion resistance is also low in the case of Comparative Example 9 where the surfactant used has neither oxyalkylene repeating unit nor reactive group. In the cases of Comparative Examples 10 and 11 where the ammonium component content of the pressure-sensitive adhesive layer is increased by changing the drying conditions, the polarization properties are low although the corrosion resistance is good despites the use of the reactive surfactant having at least four oxyalkylene repeating units.

### DESCRIPTION OF REFERENCE SIGNS

In the drawings, reference sign 1 represents an optical film, 1′ an anchor layer, 2 a pressure-sensitive adhesive layer for a transparent conductive layer, 3 a transparent conductive layer, 4 a liquid crystal cell, 5 a pressure-sensitive adhesive layer, and 6 an optical film.

1. A water-dispersible pressure-sensitive adhesive composition for a transparent conductive layer, the composition comprising: a (meth)acryl-based polymer obtained by polymerizing, in the presence of a surfactant, a monomer component comprising an alkyl(meth)acrylate having an alkyl group of 4 to 14 carbon atoms, wherein the surfactant is a reactive surfactant having three or less oxyalkylene repeating units and/or a reactive surfactant having no oxyalkylene repeating unit.

2. The water-dispersible pressure-sensitive adhesive composition for a transparent conductive layer according to claim 1, wherein the surfactant is a reactive surfactant having no oxyalkylene repeating unit.

3. The water-dispersible pressure-sensitive adhesive composition for a transparent conductive layer according to claim 1, wherein the surfactant is added in an amount of 0.1 to 30 parts by weight based on 100 parts by weight of the total amount of the monomer component used to form the (meth)acryl-based polymer.

4. The water-dispersible pressure-sensitive adhesive composition for a transparent conductive layer according to claim 1, wherein the monomer component further comprises a carboxyl group-containing monomer, and the carboxyl group-containing monomer is in an amount of 1 to 8 parts by weight based on 100 parts by weight of the alkyl(meth)acrylate having an alkyl group of 4 to 14 carbon atoms.

5. The water-dispersible pressure-sensitive adhesive composition for a transparent conductive layer according to claim 1, further comprising a water-soluble basic component.

6. The water-dispersible pressure-sensitive adhesive composition for a transparent conductive layer according to claim 5, wherein the water-soluble basic component is ammonia.

7. The water-dispersible pressure-sensitive adhesive composition for a transparent conductive layer according to claim 1, further comprising a phosphate ester compound.

8. The water-dispersible pressure-sensitive adhesive composition for a transparent conductive layer according to claim 7, wherein the phosphate ester compound is a non-polymerizable compound.

9. The water-dispersible pressure-sensitive adhesive composition for a transparent conductive layer according to claim 7, wherein the phosphate ester compound is added in an amount of 0.005 to 5 parts by weight based on 100 parts by weight of the total amount of the monomer component used to form the (meth)acryl-based polymer.

10. A pressure-sensitive adhesive layer for a transparent conductive layer made from the water-dispersible pressure-sensitive adhesive composition for a transparent conductive layer according to claim 1.

11. The pressure-sensitive adhesive layer for a transparent conductive layer according to claim 10, which contains 1,000 ng or less of a water-soluble basic component per 1 cm².

12. A pressure-sensitive adhesive layer-attached optical film, comprising:
an optical film; and
the pressure-sensitive adhesive layer for a transparent conductive layer according to claim 10 provided on one surface of the optical film.

13. A liquid crystal display device comprising the pressure-sensitive adhesive layer-attached optical film according to claim 12.

14. The water-dispersible pressure-sensitive adhesive composition for a transparent conductive layer according to claim 2, wherein the surfactant is added in an amount of 0.1 to 30 parts by weight based on 100 parts by weight of the total amount of the monomer component used to form the (meth)acryl-based polymer.

15. The water-dispersible pressure-sensitive adhesive composition for a transparent conductive layer according to claim 2, wherein the monomer component further comprises a carboxyl group-containing monomer, and the carboxyl group-containing monomer is in an amount of 1 to 8 parts by weight based on 100 parts by weight of the alkyl(meth)acrylate having an alkyl group of 4 to 14 carbon atoms.

16. The water-dispersible pressure-sensitive adhesive composition for a transparent conductive layer according to claim 3, wherein the monomer component further comprises a carboxyl group-containing monomer, and the carboxyl group-containing monomer is in an amount of 1 to 8 parts by weight based on 100 parts by weight of the alkyl(meth)acrylate having an alkyl group of 4 to 14 carbon atoms.

17. The water-dispersible pressure-sensitive adhesive composition for a transparent conductive layer according to claim 2, further comprising a water-soluble basic component.

18. The water-dispersible pressure-sensitive adhesive composition for a transparent conductive layer according to claim 3, further comprising a water-soluble basic component.

19. The water-dispersible pressure-sensitive adhesive composition for a transparent conductive layer according to claim 4, further comprising a water-soluble basic component.

20. The water-dispersible pressure-sensitive adhesive composition for a transparent conductive layer according to claim 2, further comprising a phosphate ester compound.
